(19) United States
(12) Patent Application Publication
(10) Pub. No.: US 2026/0326592 A1
(43) Pub. Date: Oct. 22, 2026

(54) SINGLE-STAGE ISOLATED BIDIRECTIONAL INTEGRATED ON-BOARD CHARGING SYSTEM FOR NEW ENERGY VEHICLE

(71) Applicants: Harbin Institute of Technology, Harbin City (CN); Zhengzhou Research Institute of HIT, Zhengzhou City (CN)

(72) Inventors: Qianfan ZHANG, Harbin City (CN); Zhen WEI, Harbin City (CN); Fan ZHANG, Harbin City (CN); Chuming WANG, Harbin City (CN); San’ang JI, Zhengzhou City (CN); Shuangdi HOU, Zhengzhou City (CN)

(21) Appl. No.: 19/535,837

(22) Filed: Feb. 10, 2026

(30) Foreign Application Priority Data
Feb. 20, 2025 (CN) 202510189385.9

(51) Int. Cl. B60L 53/22; B60L 53/24; H02J 7/14; H02M 7/5387

(52) U.S. Cl. CPC B60L 53/22; B60L 53/24; H02J 7/1492; H02M 7/5387; H02J 2207/20

(57) ABSTRACT

A single-stage isolated bidirectional integrated on-board charging system for a new energy vehicle is provided, and belongs to the field of integrated on-board charging. Problems of a large size, high costs, and a high loss in an existing two-stage isolated on-board charging system are resolved. A single-stage isolated bidirectional alternating current (AC)-direct current (DC) charging/discharging topology based on reconstruction of three-phase motor windings is provided. Compared with a two-stage topology in the conventional technology, this topology is further reduced in size, costs, and loss, improving system efficiency. This single-stage isolated bidirectional AC-DC charging/discharging topology can further increase a value of a grid-side equivalent filter inductance in a charging/discharging mode. In a charging process, a motor does not rotate, enabling suppression of grid-side current harmonics, and further lowering a loss inside the motor while reducing costs. Main application to a new energy vehicle is implemented.

### CROSS REFERENCE TO RELATED APPLICATION

This patent application claims the benefit and priority of Chinese Patent Application No. 202510189385.9, filed with the China National Intellectual Property Administration on Feb. 20, 2025, the disclosure of which is incorporated by reference herein in its entirety as part of the present application.

### TECHNICAL FIELD

The present disclosure belongs to the field of integrated on-board charging.

### BACKGROUND

For an isolated integrated charging system that reuses a three-phase permanent magnet synchronous motor and a matched drive inverter to serve as a grid-side filter inductor and a power converter in a charging mode, an existing topology adopts a conventional structure including PFC+DAB, PFC+CLLC, or the like. This essentially corresponds to a two-stage configuration: an alternating current (AC)-direct current (DC) stage followed by an isolated DC-DC stage connected in series. Such two-stage charging system has a complex structure and a large quantity of switching transistors, resulting in a large size, high costs, and a high loss. In addition, for a power factor correction (PFC) stage, a zero-sequence current is injected into three windings in the charging mode in the conventional technology to prevent the motor from rotating. In this method of eliminating a torque through zero-sequence current injection, a winding inductance acting as a grid-side filter during charging is limited to a leakage inductance of the motor. Moreover, for a three-phase parallel inverter system under single-phase or direct-current input supply conditions, an equivalent grid-side filter inductance is approximately one third of a leakage inductance of a single winding. Quality of power injected into a power grid is degraded by using an excessively low equivalent grid-side inductance, manifesting as increased grid current harmonics. Additionally, losses in the motor, inverter, and other switching transistors are aggravated by using high current harmonics. These problems need to be resolved.

### SUMMARY

To resolve problems of a large size, high costs, and a high loss of an existing two-stage isolated bidirectional on-board charging system, the present disclosure provides a single-stage isolated bidirectional integrated on-board charging system for a new energy vehicle.

The single-stage isolated bidirectional integrated on-board charging system for a new energy vehicle includes a single-stage isolated bidirectional alternating current (AC)-direct current (DC) charging/discharging topology constructed from an original on-board drive system, a clamping capacitor C_{c}, a switch, a high-frequency transformer, and a full-bridge converter, for charging or discharging an on-board battery.

In a charging/discharging mode, a connection manner of three-phase windings of a three-phase motor of the original on-board drive system is changed by using the switch, the three-phase windings of the three-phase motor of the original on-board drive system are reused as a power factor correction (PFC) inductor, a three-phase inverter of the original on-board drive system is reused as an AC-AC converter, power frequency alternating-current power output from a single-phase power supply is converted into high-frequency alternating-current power that is then supplied via the clamping capacitor C_{c} to the high-frequency transformer; and after voltage transformation is performed by the high-frequency transformer, the high-frequency alternating-current power is transmitted to the full-bridge converter for rectification, and after being stabilized by a bus capacitor C_{bat} of the original on-board drive system, is supplied to the on-board battery for charging.

Preferably, the switch includes single-pole single-throw switches K₁, K₃₁, and K₃₂, and single-pole double-throw switches K₂₁, and K₂₂.

Input terminals of an a-phase winding, a b-phase winding, and a c-phase winding of the three-phase motor are respectively connected to a terminal of the switch K₁, a second alternating-current output terminal and a third alternating-current output terminal of the three-phase inverter, and another terminal of the switch K₁ is connected to a first alternating-current output terminal of the three-phase inverter; and the first alternating-current output terminal and the second alternating-current output terminal of the three-phase inverter are further respectively connected to a terminal of the single-pole single-throw switch K₃₁ and a terminal of the single-pole single-throw switch K₃₂; and another terminal of the single-pole single-throw switch K₃₁ and another terminal of the single-pole single-throw switch K₃₂ are respectively connected to a terminal and another terminal of a primary winding of the high-frequency transformer.

Two terminals of a secondary winding of the high-frequency transformer are respectively connected to two single-phase alternating-current terminals of the full-bridge converter, and two direct-current terminals of the full-bridge converter are respectively used as a second selection terminal of the single-pole double-throw switch K₂₁ and a second selection terminal of the single-pole double-throw switch K₂₂.

A first direct-current input terminal of the three-phase inverter is connected to both a terminal of the clamping capacitor C_{c} and a first selection terminal of the single-pole double-throw switch K₂₁, and a second direct-current input terminal of the three-phase inverter is connected to both another terminal of the clamping capacitor C_{c} and a first selection terminal of the single-pole double-throw switch K₂₂; and two terminals that are of the bus capacitor C_{bat} and that are connected to the on-board battery in parallel are respectively connected to a fixed terminal of the single-pole double-throw switch K₂₁ and a fixed terminal of the single-pole double-throw switch K₂₂.

In a drive mode, the single-pole single-throw switch K₁ is in a closed state, both the single-pole double-throw switch K₂₁ and the single-pole double-throw switch K₂₂ are switched to the first selection terminals, and the single-pole single-throw switch K₃₁ and the single-pole single-throw switch K₃₂ are in an open state.

In a charging mode, two terminals of the single-pole single-throw switch K₁ are configured to be respectively connected to two charging terminals P_{g1} and P_{g2} of the single-phase power supply, the single-pole single-throw switch K₁ is in the open state, both the single-pole double-throw switch K₂₁ and the single-pole double-throw switch K₂₂ are switched to the second selection terminals, and both the single-pole single-throw switch K₃₁ and the single-pole single-throw switch K₃₂ are in the closed state.

Preferably, the three-phase inverter is a three-phase full-bridge inverter, the first alternating-current output terminal, the second alternating-current output terminal, and the third alternating-current output terminal of the three-phase inverter are respectively midpoints of an a-phase half-bridge, a b-phase half-bridge, and a c-phase half-bridge of the three-phase inverter.

The a-phase half-bridge of the three-phase inverter includes upper and lower power switching transistors S₃ and S₄, the b-phase half-bridge of the three-phase inverter includes upper and lower power switching transistors S₅ and S₆, and the c-phase half-bridge of the three-phase inverter includes upper and lower power switching transistors S₁ and S₂.

In the charging/discharging mode, the power switching transistors S₁ and S₂ are alternately turned on at a grid frequency of 50 Hz, the power switching transistors S₃ and S₄ are alternately turned on with a 50% duty cycle, and the power switching transistors S₅ and S₆ are alternately turned on with the 50% duty cycle.

When a grid-side voltage Vg is greater than 0, the power switching transistor S₁ is turned off, and the power switching transistor S₂ is turned on; or when the grid-side voltage Vg is less than or equal to 0, the power switching transistor S₁ is turned on, and the power switching transistor S₂ is turned off, where the grid-side voltage Vg is the power frequency alternating-current power output from the single-phase power supply.

Preferably, a voltage V_{Cc} at two terminals of the clamping capacitor C_{c} is twice a grid-side voltage Vg, and the grid-side voltage Vg is the power frequency alternating-current power output from the single-phase power supply.

Preferably, the high-frequency transformer is implemented using a single-phase half-bridge inverter, carrier waves of two switching transistors in each of two branches of the single-phase half-bridge inverter have a 180° phase shift, and both are modulated using a signal d(t), where d(t)=k|sin(ω_{g}t)|, k is a coefficient, k∈[0,0.5], ω_{g} is a grid angular frequency, and t is time.

Preferably, a-phase equivalent filter inductance L_{ega}, a b-phase equivalent filter inductance L_{egb}, and a c-phase equivalent filter inductance L_{egc} of the PFC inductor are respectively as follows:

$${L}_{e q a} = {L}_{σ s} + \frac{{L}_{m} + 3 L - 3 {L}_{Δ1} cos ( 2 θ ) - 3 \sqrt{3} {L}_{Δ 1} sin ( 2 θ )}{2}$$

$${L}_{e q b} = {L}_{σ s} + \frac{{L}_{m} + 3 L + 3 {L}_{Δ 1} cos ( 2 θ ) - \sqrt{3} {L}_{Δ 1} sin ( 2 θ )}{2}$$

$${L}_{e q c} = {L}_{σ s} + \frac{{L}_{m} + 3 L}{2} + \frac{3 {L}_{Δ 1} cos ( 2 θ ) + \sqrt{3} {L}_{Δ 1} sin ( 2 θ )}{4}$$

where L_{σs} is a motor winding self-leakage inductance, Lₘ is a mutual leakage inductance between motor windings, L is an average value of motor winding self-inductances, L_{Δ1} is an amplitude of a second harmonic of the motor winding self-inductance, and θ is a rotor position angle.

The present disclosure has the advantages:

The present disclosure discloses a single-stage isolated bidirectional AC-DC charging/discharging topology based on reconstruction of three-phase motor windings. Compared with a two-stage topology in the conventional technology, this topology is further reduced in size, costs, and loss, improving system efficiency. This single-stage isolated bidirectional AC-DC charging/discharging topology can further increase a value of a grid-side equivalent filter inductance in a charging/discharging mode. In a charging process, a motor does not rotate, enabling suppression of grid-side current harmonics, further lowering a loss inside the motor while reducing costs, and further improving system efficiency.

### BRIEF DESCRIPTION OF THE DRAWINGS

FIG. 1 is a schematic structural diagram of a single-stage isolated bidirectional integrated on-board charging system for a new energy vehicle according to the present disclosure, where Lₛ is a leakage inductance of a primary winding of a high-frequency transformer;

FIG. 2 is an equivalent circuit diagram of an integrated on-board charging system in a drive mode according to the present disclosure;

FIG. 3 is an equivalent circuit diagram of an integrated on-board charging system in a charging mode according to the present disclosure;

FIG. 4 is a diagram showing on-off states and voltage waveforms on a primary side of a high-frequency transformer; where S_{1,4} indicates power switching transistors S₁ and S₄, S_{2,3} indicates power switching transistors S₂ and S₃, V_{g,peak} indicates a peak voltage of a grid-side voltage V_{g}, V_{a,b} indicates a voltage between a midpoint a of an a-phase bridge arm and a midpoint b of a b-phase bridge arm of a three-phase inverter, and V_{Cc} indicates a voltage across a clamping capacitor C_{c};

FIG. 5 is a diagram showing on-off states and voltage waveforms on a secondary side of a high-frequency transformer; where C_{φ} is a carrier wave of a switching transistor S₉, C_{φ+π} is a carrier wave of a switching transistor S₇, V_{cd} is a voltage between midpoints c and d of two bridge arms of a full-bridge converter, and V_{bat} is a battery voltage;

FIGS. 6A-6D are simulation waveform diagrams in a G2V mode, where FIG. 6A is a waveform diagram of an input voltage and an input current from a single-phase power supply to a three-phase motor in the G2V mode; FIG. 6B is a waveform diagram of a clamping capacitor voltage and a battery current; FIG. 6C is a waveform diagram of an a-phase current and a b-phase current of a three-phase motor; and FIG. 6D is a magnified view of the waveforms in FIG. 6C;

FIGS. 7A-7D are simulation waveform diagrams in a V2G mode, where FIG. 7A is a waveform diagram of an input voltage and an input current from a single-phase power supply to a three-phase motor in the V2G mode; FIG. 7B is a waveform diagram of a clamping capacitor voltage and a battery current; FIG. 7C is a waveform diagram of an a-phase current and a b-phase current of a three-phase motor; and FIG. 7D is a magnified view of the waveforms in FIG. 7C; and

FIG. 8 is a simulation result diagram of a motor torque under single-phase alternating-current charging.

### DETAILED DESCRIPTION OF THE EMBODIMENTS

The technical solutions in embodiments of the present disclosure are clearly and completely described below with reference to the drawings in embodiments of the present disclosure. Apparently, the described embodiments are merely a part rather than all of embodiments of the present disclosure. All other embodiments obtained by those of ordinary skill in the art based on embodiments of the present disclosure without creative efforts shall fall within a protection scope of the present disclosure.

It should be noted that embodiments in the present disclosure or features in the embodiments may be combined in a non-conflicting manner.

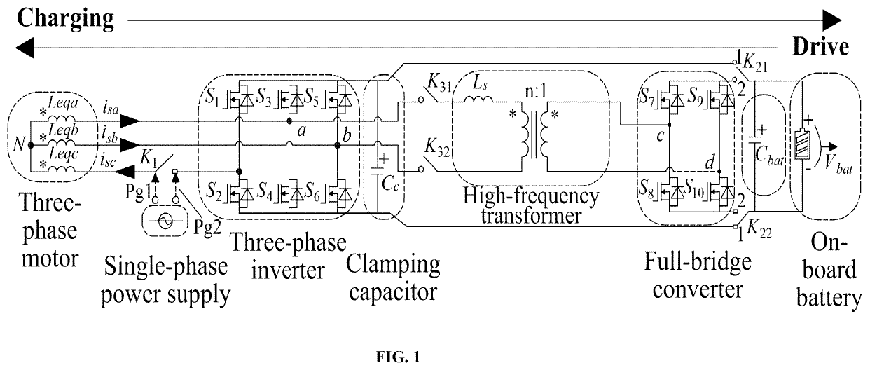

This embodiment is described below with reference to FIG. 1. A single-stage isolated bidirectional integrated on-board charging system for a new energy vehicle in this embodiment includes a single-stage isolated bidirectional alternating current (AC)-direct current (DC) charging/discharging topology constructed from an original on-board drive system, a clamping capacitor C_{c}, a switch, a high-frequency transformer, and a full-bridge converter, for charging or discharging an on-board battery.

In a charging/discharging mode, a connection manner of three-phase windings of a three-phase motor of the original on-board drive system is changed by using the switch, the three-phase windings of the three-phase motor of the original on-board drive system are reused as a power factor correction (PFC) inductor, a three-phase inverter of the original on-board drive system is reused as an AC-AC converter, power frequency alternating-current power output from a single-phase power supply is converted into high-frequency alternating-current power that is then supplied via the clamping capacitor C_{c} to the high-frequency transformer; and after voltage transformation is performed by the high-frequency transformer, the high-frequency alternating-current power is transmitted to the full-bridge converter for rectification, and after being stabilized by a bus capacitor C_{bat} of the original on-board drive system, is supplied to the on-board battery for charging.

During a practical application, the high-frequency transformer may be generally a transformer operating at a frequency higher than 20 kHz. A turns ratio between primary and secondary windings of the high-frequency transformer may be n:1, where n is an integer.

Compared with a two-stage topology in the conventional technology, the single-stage isolated bidirectional AC-DC charging/discharging topology constructed in this embodiment achieves further reduction in size, costs, and loss, thereby enhancing system efficiency.

Further, refer to FIG. 1. The switch includes single-pole single-throw switches K₁, K₃₁, and K₃₂, and single-pole double-throw switches K₂₁, and K₂₂.

Input terminals of an a-phase winding, a b-phase winding, and a c-phase winding of the three-phase motor are respectively connected to a terminal of the switch K₁, a second alternating-current output terminal and a third alternating-current output terminal of the three-phase inverter, and another terminal of the switch K₁ is connected to a first alternating-current output terminal of the three-phase inverter; and the first alternating-current output terminal and the second alternating-current output terminal of the three-phase inverter are further respectively connected to a terminal of the single-pole single-throw switch K₃₁ and a terminal of the single-pole single-throw switch K₃₂; and another terminal of the single-pole single-throw switch K₃₁ and another terminal of the single-pole single-throw switch K₃₂ are respectively connected to a terminal and another terminal of a primary winding of the high-frequency transformer.

Two terminals of a secondary winding of the high-frequency transformer are respectively connected to two single-phase alternating-current terminals of the full-bridge converter, and two direct-current terminals of the full-bridge converter are respectively used as a second selection terminal of the single-pole double-throw switch K₂₁ and a second selection terminal of the single-pole double-throw switch K₂₂.

A first direct-current input terminal of the three-phase inverter is connected to both a terminal of the clamping capacitor C_{c} and a first selection terminal of the single-pole double-throw switch K₂₁, and a second direct-current input terminal of the three-phase inverter is connected to both another terminal of the clamping capacitor C_{c} and a first selection terminal of the single-pole double-throw switch K₂₂.

Two terminals that are of the bus capacitor C_{bat} and that are connected to the on-board battery in parallel are respectively connected to a fixed terminal of the single-pole double-throw switch K₂₁ and a fixed terminal of the single-pole double-throw switch K₂₂.

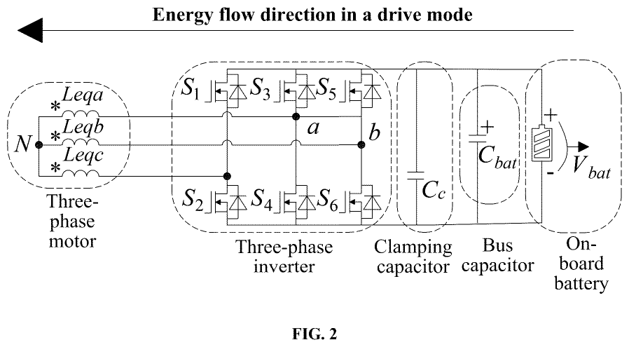

Refer to FIG. 2. In a drive mode, the single-pole single-throw switch K₁ is in a closed state, both the single-pole double-throw switch K₂₁ and the single-pole double-throw switch K₂₂ are switched to the first selection terminals, and the single-pole single-throw switch K₃₁ and the single-pole single-throw switch K₃₂ are in an open state.

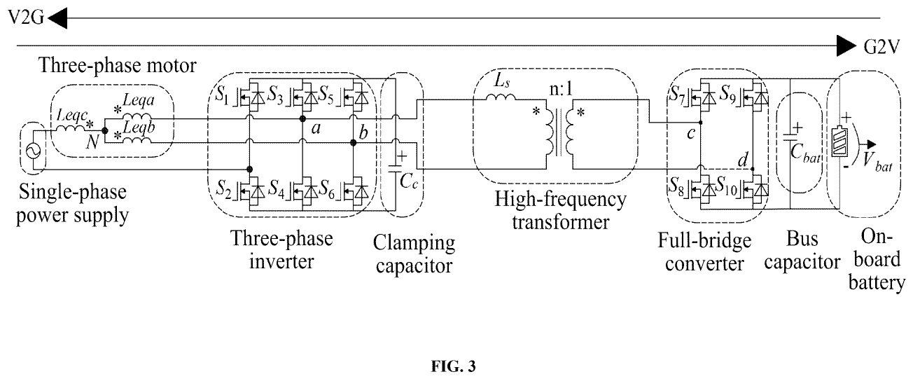

Refer to FIG. 3. In a charging mode, two terminals of the single-pole single-throw switch K₁ are configured to be respectively connected to two charging terminals P_{g1} and P_{g2} of the single-phase power supply, the single-pole single-throw switch K₁ is in the open state, both the single-pole double-throw switch K₂₁ and the single-pole double-throw switch K₂₂ are switched to the second selection terminals, and both the single-pole single-throw switch K₃₁ and the single-pole single-throw switch K₃₂ are in the closed state. During specific charging operations, energy passes through the motor windings from a charging gun on an alternating-current charging pile acting as a single-phase power source. After power frequency alternating-current power output from the single-phase power supply and a current output from the single-phase power supply are effectively regulated via the three-phase inverter, the energy is then transferred to the high-frequency transformer and the full-bridge converter. A wide-range voltage regulation capability is provided by the full-bridge converter, delivering the input energy smoothly and safely to the on-board battery.

A specific structure of the single-stage isolated bidirectional AC-DC charging/discharging topology is provided in this preferable implementation. A working mode of an integrated charging system is implemented by using the switch and changing a winding connection manner. The single-stage isolated bidirectional AC-DC charging/discharging topology can further increase a value of a grid-side equivalent filter inductance in a charging/discharging mode. In a charging process, a motor does not rotate, enabling suppression of grid-side current harmonics, further lowering a loss inside the motor while reducing costs, and further improving system efficiency.

Further, the three-phase inverter is a three-phase full-bridge inverter, the first alternating-current output terminal, the second alternating-current output terminal, and the third alternating-current output terminal of the three-phase inverter are respectively midpoints of an a-phase half-bridge, a b-phase half-bridge, and a c-phase half-bridge of the three-phase inverter.

The a-phase half-bridge of the three-phase inverter includes upper and lower power switching transistors S₃ and S₄, the b-phase half-bridge of the three-phase inverter includes upper and lower power switching transistors S₅ and S₆, and the c-phase half-bridge of the three-phase inverter includes upper and lower power switching transistors S₁ and S₂.

In the charging/discharging mode, the power switching transistors S₁ and S₂ are alternately turned on at a grid frequency of 50 Hz, the power switching transistors S₃ and S₄ are alternately turned on with a 50% duty cycle, and the power switching transistors S₅ and S₆ are alternately turned on with the 50% duty cycle.

When a grid-side voltage Vg is greater than 0, the power switching transistor S₁ is turned off, and the power switching transistor S₂ is turned on; or when the grid-side voltage Vg is less than or equal to 0, the power switching transistor S₁ is turned on, and the power switching transistor S₂ is turned off; and the grid-side voltage Vg is the power frequency alternating-current power output from the single-phase power supply.

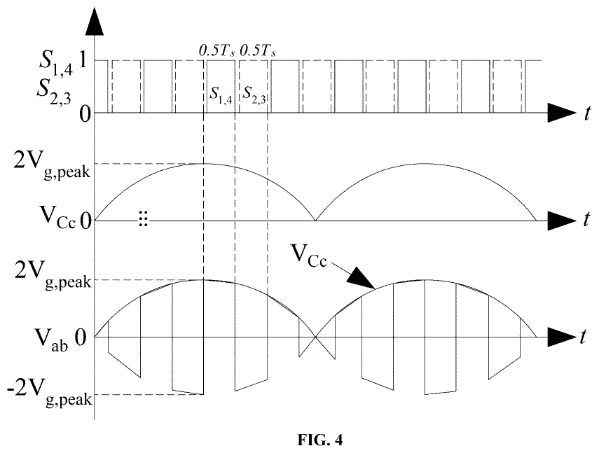

Regardless of a power level, a voltage V_{Cc} at two terminals of the clamping capacitor C_{c} is twice a grid-side voltage Vg, and the grid-side voltage Vg is the power frequency alternating-current power output from the single-phase power supply. The power on-off states and voltage waveforms on the primary side of the high-frequency transformer are shown in FIG. 4. FIG. 4 shows that the switching transistors S₁ and S₄ have same driving waveforms, the switching transistors S₂ and S₃ also have same driving waveforms that are complementary to those of S₁ and S₄. A voltage waveform of the clamping capacitor voltage V_{Cc} is a half-sinusoidal waveform form with a peak value of 2V_{g,peak}. An input voltage V_{ab} on the primary side of the high-frequency transformer depends on the working states of the switching transistors: When the switching transistors S₁ and S₄ are turned on, V_{ab} is V_{Cc}; when the switching transistors S₂ and S₃ are turned on, V_{ab} is −V_{Cc}.

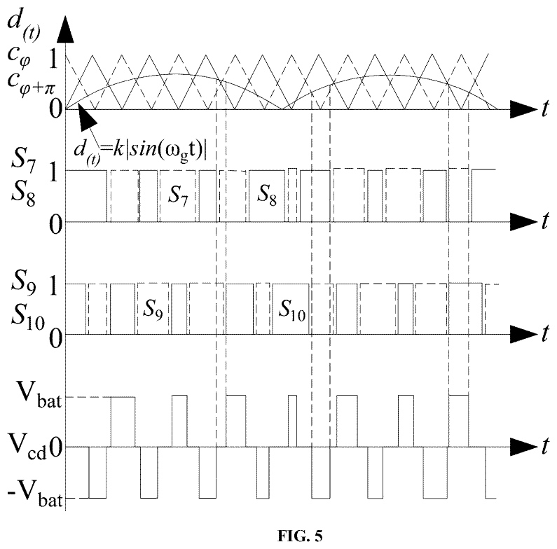

Further refer to FIG. 5. The high-frequency transformer is implemented using a single-phase half-bridge inverter, carrier waves of two switching transistors in each of two branches of the single-phase half-bridge inverter have a 180° phase shift, and both are modulated using a signal d(t).

d(t)=k|sin(ω_{g}t)| (1)
k is a coefficient, k∈[0,0.5], ω_{g} is a grid angular frequency, and t is time.

FIG. 5 shows that a carrier wave C_{φ} of the switching transistor S₇ and a carrier wave C_{φ+π} of the switching transistor S₉ have a phase difference of 180 degrees. When a modulation wave d(t) is greater than the carrier wave C_{φ}, the switching transistor S₉ is turned on. When the modulation wave d(t) is greater than the carrier wave C_{φ+π}, the switching transistor S₇ is turned on. The switching transistor S₈ and the switching transistor S₇ are turned on complementarily, and the switching transistor S₁₀ and the switching transistor S₉ are turned on complementarily. When the switching transistor S₇ and the switching transistor S₁₀ are simultaneously turned on, the secondary-side voltage V_{cd} of the high-frequency transformer is a load voltage V_{bat}. When the switching transistor S₈ and the switching transistor S₉ are simultaneously turned on, V_{cd} is −V_{bat}. In all other cases, V_{cd} is 0.

Further, to analyze an inductance of the motor windings that are reconstructed as the grid-side filter inductance, specifically, as the PFC inductance, the procedure is as follows:

For a three-phase motor, expressions for the self-inductance and mutual inductance of windings of the three-phase motor are as follows:

$$\{ \begin{matrix}{L}_{a} = {L}_{σ s} + L - {L}_{Δ1} cos ( 2 θ ) \\ {L}_{b} = {L}_{σ s} + L - {L}_{Δ 1} cos ( 2 θ - \frac{2 π}{3} ) \\ {L}_{c} = {L}_{σ s} + L - {L}_{Δ1} cos ( 2 θ + \frac{2 π}{3} )\end{matrix} \qquad ( 2 )$$

$${M}_{a b} = {M}_{b a} = {L}_{m} cos ( \frac{2 π}{3} ) + L cos ( \frac{2 π}{3} ) - {L}_{Δ1} cos ( 2 θ - \frac{2 π}{3} ) \qquad ( 3 )$$

$${M}_{a c} = {M}_{c a} = {L}_{m} cos ( \frac{2 π}{3} ) + L cos ( \frac{2 π}{3} ) - {L}_{Δ1} c o s ( 2 θ + \frac{2 π}{3} ) \qquad ( 4 )$$

$${M}_{b c} = {M}_{c b} = {L}_{m} cos ( \frac{2 π}{3} ) + L cos ( \frac{2 π}{3} ) - {L}_{Δ1} cos ( 2 θ - 2 π ) \qquad ( 5 )$$

L_{σs} is a motor winding self-leakage inductance, windings of phases in the three-phase motor are equal in value, Lₘ is a mutual leakage inductance, mainly a slot mutual leakage inductance between motor windings, L is an average value of motor winding self-inductances, L_{Δ1} is an amplitude of a second harmonic of the motor winding self-inductance, and θ is a rotor position angle.

An inductance matrix of the three-phase winding motor is expressed as follows:

$${L}_{ss} = {[ \begin{matrix}{L}_{aa} & {M}_{ab} & {M}_{a c} \\ {M}_{b a} & {L}_{b b} & {M}_{b c} \\ {M}_{ca} & {M}_{cb} & {L}_{cc}\end{matrix} ]}_{3 \times 3} \qquad ( 6 )$$

In the charging mode, a motor winding current can be expressed as follows:

iₛ=[iₛₐi_{sb}i_{sc}]^{T} (7)

A stator winding flux linkage along abc-phase axes of the motor is ψₛₘ, with m=a, b, c, and can be represented by using a motor winding equivalent inductance L_{eqm} and a motor permanent magnet flux linkage ψfₘ:

$$[ \begin{matrix}\begin{matrix}{ψ}_{sa} \\ {ψ}_{s b}\end{matrix} \\ {ψ}_{sc}\end{matrix} ] = [ \begin{matrix}{L}_{e q a} & 0 & 0 \\ 0 & {L}_{e q b} & 0 \\ 0 & 0 & {L}_{e q c}\end{matrix} ] [ \begin{matrix}{i}_{sa} \\ {i}_{s b} \\ {i}_{sc}\end{matrix} ] + [ \begin{matrix}\begin{matrix}{ψ}_{fa} \\ {ψ}_{fb}\end{matrix} \\ {ψ}_{fc}\end{matrix} ] \qquad ( 8 )$$

Using a stator inductance matrix Lₛₛ, a flux linkage

$${ψ}_{ss} = [ \begin{matrix}{ψ}_{sa} \\ {ψ}_{sb} \\ {ψ}_{sc}\end{matrix} ]$$

represented by the second term in the above formula is expanded as follows:

ψₛₛ=Lₛₛiₛ (9)

Therefore, the motor winding equivalent inductance L_{eqss} can be expressed as follows:

$${L}_{e q s s} = {[ {L}_{e q a} , {L}_{e q b} , {L}_{e q c} ]}^{T} = \frac{{ψ}_{s s}}{{i}_{s}} \qquad ( 10 )$$

ψₛₛ indicates a stator flux linkage generated by motor winding current excitation;
   indicates an element-wise division operator in the matrix.

Based on FIG. 3, if an absolute value of a magnitude of a current flowing through the phase c is twice an absolute value of a magnitude of a current flowing through the phase a and an absolute value of a magnitude of a current flowing through the phase b, the following can be obtained:

i_{sc}=−2iₛₐ=−2i_{sb}=Iₘ cos(ω_{g}t) (11)

Iₘ is a peak value of the grid-side current.

The formula (11) is substituted into the formula (10), the equivalent filter inductance can be calculated based on the foregoing inductance matrix as follows.

An a-phase equivalent filter inductance L_{eqa}, a b-phase equivalent filter inductance L_{eqb}, and a c-phase equivalent filter inductance L_{eqc} of the PFC inductor are respectively as follows:

$${L}_{e q a} = {L}_{σ s} + \frac{{L}_{m} + 3 L - 3 {L}_{Δ1} cos ( 2 θ ) - 3 \sqrt{3} {L}_{Δ 1} sin ( 2 θ )}{2} \qquad ( 12 )$$

$${L}_{e q b} = {L}_{σ s} + \frac{{L}_{m} + 3 L + 3 {L}_{Δ 1} cos ( 2 θ ) - \sqrt{3} {L}_{Δ 1} sin ( 2 θ )}{2} \qquad ( 13 )$$

$${L}_{e q c} = {L}_{σ s} + \frac{{L}_{m} + 3 L}{2} + \frac{3 {L}_{Δ 1} cos ( 2 θ ) + \sqrt{3} {L}_{Δ 1} sin ( 2 θ )}{4} \qquad ( 14 )$$

Therefore, it can be learned that the equivalent inductance at this time includes the self-inductance of the windings. As a result, compared with a case of zero-sequence current injection, the equivalent inductance has been significantly increased. This helps reduce grid-side current harmonics and enhance the system charging efficiency.

### Verification Test:

The technical effects of the present disclosure are described through the following verification test, specifically as follows.

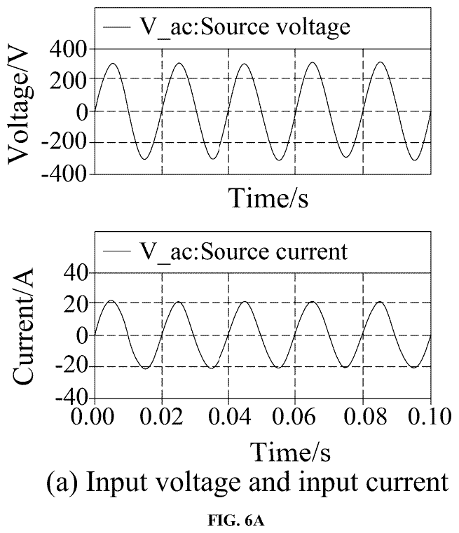

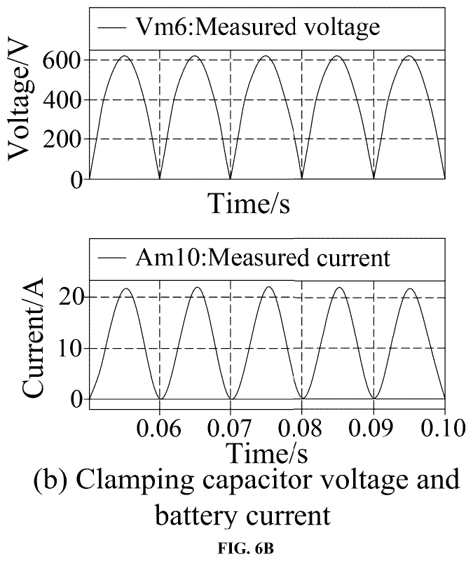

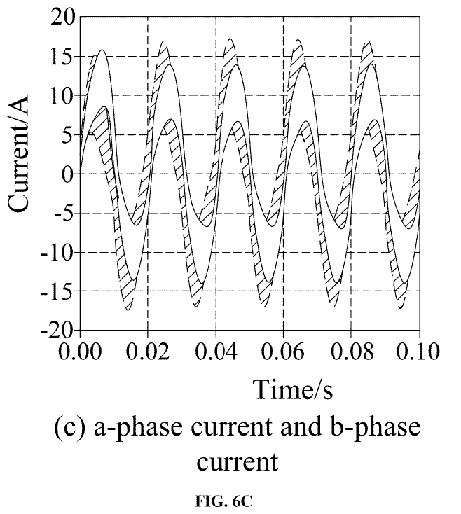

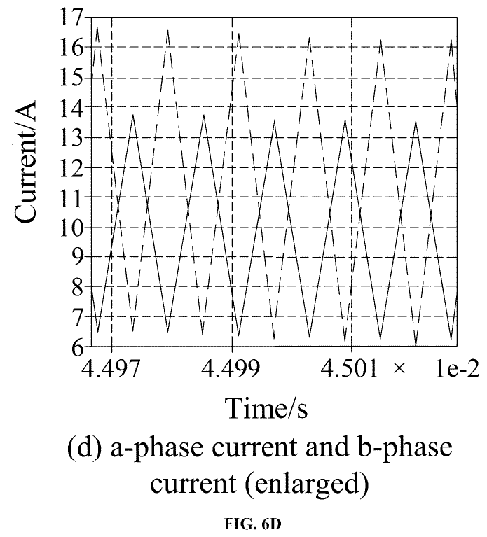

Simulation results in the charging mode (namely, G2V mode) and the discharging mode (namely, V2G mode) are shown. In the G2V mode, waveforms of the input voltage and the input current, and waveforms of the clamping capacitor voltage and the battery current are shown in FIGS. 6A-6D. Specifically, in FIG. 6A, the input current is in phase with the input voltage, verifying that the proposed topology and the control method can achieve the PFC function. FIG. 6B verifies that the clamping capacitor voltage is a half-sinusoidal waveform with a peak value twice that of the grid-side voltage peak V_{g, peak}, and that the battery current is positive in the G2V mode, indicating the battery is in a charging state. FIG. 6C shows that in the G2V mode, the magnitudes and phases of the a-phase current and the b-phase current are not completely the same as the a-phase equivalent impedance and the b-phase equivalent impedance are not completely the same. FIG. 6D shows that in the G2V mode, the a-phase current waveform and the b-phase current waveform have a phase difference of 180 degrees at a high frequency, verifying the accuracy of the control method.

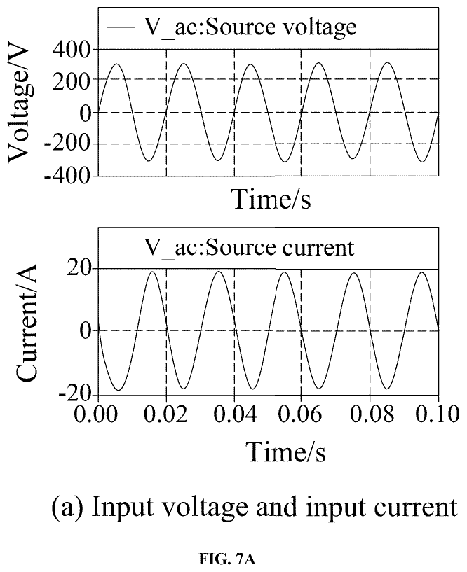

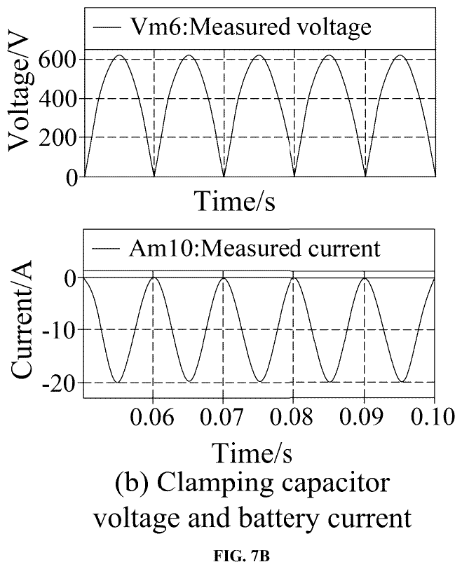

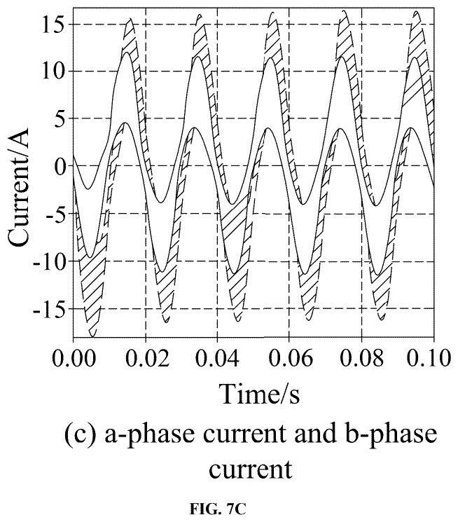

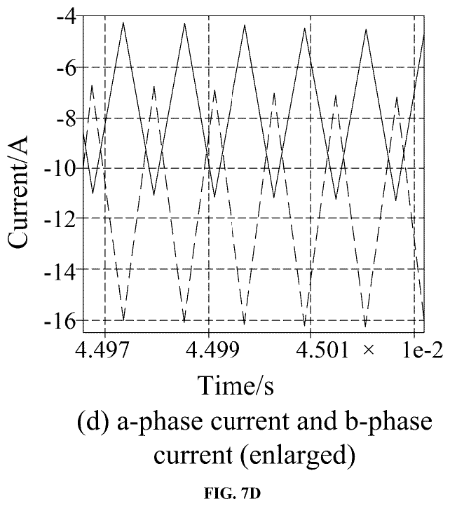

In the V2G mode, waveforms of the input voltage and the input current, and waveforms of the clamping capacitor voltage and the battery current are shown in FIGS. 7A-7D. Specifically, in FIG. 7A, the input current is out of phase with the input voltage, that is, a power factor is −1, verifying that the proposed topology and the control method can achieve the V2G function. FIG. 7B verifies that the clamping capacitor voltage is a half-sinusoidal waveform with a peak value twice that of the grid-side voltage peak V_{g, peak}, and that the battery current is negative in the V2G mode, indicating the battery is in a discharging state. FIG. 7C shows that in the V2G mode, the magnitudes and phases of the a-phase current and the b-phase current are not completely the same as the a-phase equivalent impedance and the b-phase equivalent impedance are not completely the same. FIG. 7D shows that in the V2G mode, the a-phase current waveform and the b-phase current waveform have a phase difference of 180 degrees at a high frequency, verifying the accuracy of the control method.

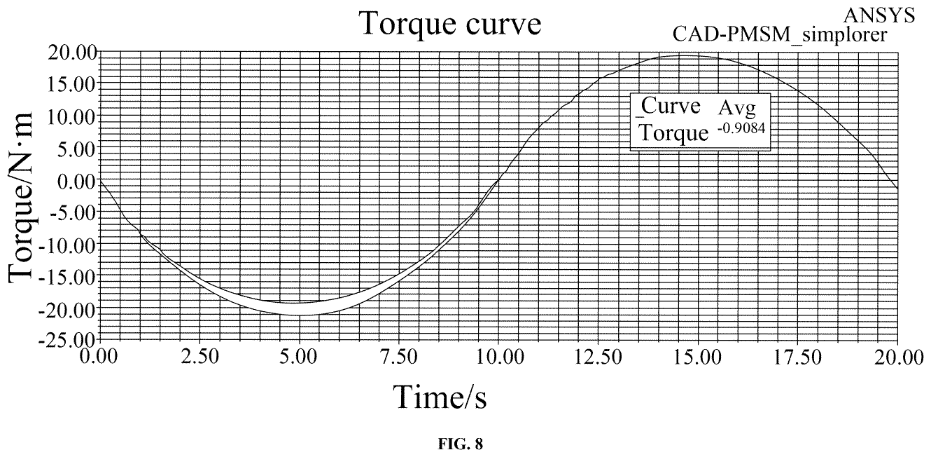

Furthermore, torque simulation results based on this integrated topology at a charging power of 6.6 kW are provided, as shown in FIG. 8. It can be learned that the average motor torque in the charging mode is essentially zero, and the motor does not rotate, which verifies the effectiveness of the present disclosure.

Although the present disclosure has been described herein with reference to specific embodiments, it should be understood that these embodiments are merely examples of the principles and applications of the present disclosure. Therefore, it should be understood that various modifications can be made to the exemplary embodiments, and other arrangements can be designed, without departing from the spirit and scope of the present disclosure as defined by the appended claims. It should be understood that features from different dependent claims and those described herein may be combined in ways other than those described in the original claims. It may be further understood that features described in connection with individual embodiments may be used in other described embodiments.

What is claimed is:

1. A single-stage isolated bidirectional integrated on-board charging system for a new energy vehicle, comprising: a single-stage isolated bidirectional alternating current (AC)-direct current (DC) charging/discharging topology constructed from an original on-board drive system, a clamping capacitor C_{c}, a switch, a high-frequency transformer, and a full-bridge converter, for charging or discharging an on-board battery, wherein
in a charging/discharging mode, a connection manner of three-phase windings of a three-phase motor of the original on-board drive system is changed by using the switch, the three-phase windings of the three-phase motor of the original on-board drive system are reused as a power factor correction (PFC) inductor, a three-phase inverter of the original on-board drive system is reused as an AC-AC converter, power frequency alternating-current power output from a single-phase power supply is converted into high-frequency alternating-current power that is then supplied via the clamping capacitor C_{c} to the high-frequency transformer; and after voltage transformation is performed by the high-frequency transformer, the high-frequency alternating-current power is transmitted to the full-bridge converter for rectification, and after being stabilized by a bus capacitor C_{bat} of the original on-board drive system, is supplied to the on-board battery for charging;
the switch comprises single-pole single-throw switches K₁, K₃₁, and K₃₂, and single-pole double-throw switches K₂₁ and K₂₂;
input terminals of an a-phase winding, a b-phase winding, and a c-phase winding of the three-phase motor are respectively connected to a terminal of the switch K₁, a second alternating-current output terminal and a third alternating-current output terminal of the three-phase inverter, and another terminal of the switch K₁ is connected to a first alternating-current output terminal of the three-phase inverter; and the first alternating-current output terminal and the second alternating-current output terminal of the three-phase inverter are further respectively connected to a terminal of the single-pole single-throw switch K₃₁ and a terminal of the single-pole single-throw switch K₃₂; and another terminal of the single-pole single-throw switch K₃₁ and another terminal of the single-pole single-throw switch K₃₂ are respectively connected to a terminal and another terminal of a primary winding of the high-frequency transformer;
two terminals of a secondary winding of the high-frequency transformer are respectively connected to two single-phase alternating-current terminals of the full-bridge converter, and two direct-current terminals of the full-bridge converter are respectively used as a second selection terminal of the single-pole double-throw switch K₂₁ and a second selection terminal of the single-pole double-throw switch K₂₂;
a first direct-current input terminal of the three-phase inverter is connected to both a terminal of the clamping capacitor C_{c} and a first selection terminal of the single-pole double-throw switch K₂₁, and a second direct-current input terminal of the three-phase inverter is connected to both another terminal of the clamping capacitor C_{c} and a first selection terminal of the single-pole double-throw switch K₂₂; and two terminals that are of the bus capacitor C_{bat} and that are connected to the on-board battery in parallel are respectively connected to a fixed terminal of the single-pole double-throw switch K₂₁ and a fixed terminal of the single-pole double-throw switch K₂₂;
in a drive mode, the single-pole single-throw switch K₁ is in a closed state, both the single-pole double-throw switch K₂₁ and the single-pole double-throw switch K₂₂ are switched to the first selection terminals, and the single-pole single-throw switch K₃₁ and the single-pole single-throw switch K₃₂ are in an open state; and
in a charging mode, two terminals of the single-pole single-throw switch K₁ are configured to be respectively connected to two charging terminals P_{g1} and P_{g2} of the single-phase power supply, the single-pole single-throw switch K₁ is in the open state, both the single-pole double-throw switch K₂₁ and the single-pole double-throw switch K₂₂ are switched to the second selection terminals, and both the single-pole single-throw switch K₃₁ and the single-pole single-throw switch K₃₂ are in the closed state.

2. The single-stage isolated bidirectional integrated on-board charging system for a new energy vehicle according to claim 1, wherein the three-phase inverter is a three-phase full-bridge inverter, the first alternating-current output terminal, the second alternating-current output terminal, and the third alternating-current output terminal of the three-phase inverter are respectively midpoints of an a-phase half-bridge, a b-phase half-bridge, and a c-phase half-bridge of the three-phase inverter;
the a-phase half-bridge of the three-phase inverter comprises upper and lower power switching transistors S₃ and S₄, the b-phase half-bridge of the three-phase inverter comprises upper and lower power switching transistors S₅ and S₆, and the c-phase half-bridge of the three-phase inverter comprises upper and lower power switching transistors S₁ and S₂;
in the charging/discharging mode, the power switching transistors S₁ and S₂ are alternately turned on at a grid frequency of 50 Hz, the power switching transistors S₃ and S₄ are alternately turned on with a 50% duty cycle, and the power switching transistors S₅ and S₆ are alternately turned on with the 50% duty cycle; and
when a grid-side voltage Vg is greater than 0, the power switching transistor S₁ is turned off, and the power switching transistor S₂ is turned on; or when the grid-side voltage Vg is less than or equal to 0, the power switching transistor S₁ is turned on, and the power switching transistor S₂ is turned off, wherein the grid-side voltage Vg is the power frequency alternating-current power output from the single-phase power supply.

3. The single-stage isolated bidirectional integrated on-board charging system for a new energy vehicle according to claim 1, wherein a voltage V_{Cc} at two terminals of the clamping capacitor C_{c} is twice a grid-side voltage Vg, and the grid-side voltage Vg is the power frequency alternating-current power output from the single-phase power supply.

4. The single-stage isolated bidirectional integrated on-board charging system for a new energy vehicle according to claim 1, wherein the high-frequency transformer is implemented using a single-phase half-bridge inverter, carrier waves of two switching transistors in each of two branches of the single-phase half-bridge inverter have a 180° phase shift, and both are modulated using a signal d(t), wherein d(t)=k|sin(ω_{g}t)|, k is a coefficient, k∈[0,0.5], ω_{g} is a grid angular frequency, and t is time.

5. The single-stage isolated bidirectional integrated on-board charging system for a new energy vehicle according to claim 1, wherein a-phase equivalent filter inductance L_{eqa}, a b-phase equivalent filter inductance L_{egb}, and a c-phase equivalent filter inductance L_{eqc} of the PFC inductor are respectively as follows:
$${L}_{e q a} = {L}_{σ s} + \frac{{L}_{m} + 3 L - 3 {L}_{Δ1} cos ( 2 θ ) - 3 \sqrt{3} {L}_{Δ 1} sin ( 2 θ )}{2} ;$$
$${L}_{e q b} = {L}_{σ s} + \frac{{L}_{m} + 3 L + 3 {L}_{Δ 1} cos ( 2 θ ) - \sqrt{3} {L}_{Δ 1} sin ( 2 θ )}{2} ; and$$
$${L}_{e q c} = {L}_{σ s} + \frac{{L}_{m} + 3 L}{2} + \frac{3 {L}_{Δ 1} cos ( 2 θ ) + \sqrt{3} {L}_{Δ 1} sin ( 2 θ )}{4} ,$$
wherein
L_{σs} is a motor winding self-leakage inductance, Lₘ is a mutual leakage inductance between motor windings, L is an average value of motor winding self-inductances, L_{Δ1} is an amplitude of a second harmonic of the motor winding self-inductance, and θ is a rotor position angle.
